(19) United States
(12) Patent Application Publication
(10) Pub. No.: US 2011/0093531 A1
(43) Pub. Date: Apr. 21, 2011

(54) SERVER PERSISTENCE USING A URL IDENTIFIER

(76) Inventor: Steve Schnetzler, San Diego, CA (US)

(21) Appl. No.: 12/976,384

(22) Filed: Dec. 22, 2010

Related U.S. Application Data
(63) Continuation of application No. 10/083,557, filed on Feb. 27, 2002.

(51) Int. Cl. G06F 15/16

(52) U.S. Cl. 709/203

(57) ABSTRACT

A method of accessing a web page from a plurality of servers over the Internet include receiving a request for the web page from a client computer at a load balancer and sending the request to a first server of the plurality of servers. The load balancer receives the web page from the first server and adds an identity of the first server to all URLs on the web page that reference the plurality of servers. The load balancer then forwards the data to the client computer.

### FIELD OF THE INVENTION

The present invention is directed to data access to a remote server. More particularly, the present invention is directed to maintaining persistence to a single remote server that is accessed through the Internet.

### BACKGROUND INFORMATION

In order to provide responsiveness and availability to customers, many e-commerce sites on the Internet employ multiple servers and a load balancer. In essence, the load balancer makes the multiple servers look like a single, high-powered network resource to those accessing the site. It does this by selectively forwarding connections to the many servers arrayed behind it in an equitable manner, according to the server's operational health and the nature of the query.

A problem exists because individual users must be tied to a single server and maintain persistence to that server for secure transactions and for enhancing the experience for the user. For example, navigating an online application, such as a shopping cart or stock trading system, requires a series of interactions between the visitor and the site's back-end applications. These applications need to know where a user was, so that they can decide where the user will be next. If a load balancer or other device redirects the user to a different web server during an interaction session, this may cause the connection to fail, and the user's session will be ended prematurely. In addition, the user's previously entered information, such as the contents of a shopping cart, may be lost.

This problem is commonly referred to as the “mega proxy problem”. A likely result of the lack of persistence is that the user will leave the site unsatisfied and may never return.

One way to overcome the mega proxy problem is for the user to accept cookies on the user's machine. The cookies allow the user to be directed to the correct server and maintain persistence to the server. However, many users object to accepting cookies. In addition, most wireless protocols inherently do not use cookies in an effort to conserve bandwidth.

Another solution to the mega proxy problem that can be utilized by wireless web users that do not accept cookies is referred to as “URL munging”. In Uniform Resource Locator (“URL”) munging, a session identifier is stored as part of the URL. Server software uses the session identifier to identify that user's session. However, URL munging requires costly modifications to be made to the individual web servers.

Based on the foregoing, there is a need for an improved method for maintaining persistence with a web server while using a load balancer.

### BRIEF DESCRIPTION OF THE DRAWINGS

FIG. 1 is a block diagram of a system in accordance with one embodiment of the present invention.

FIG. 2 is a flow diagram of the steps performed by a load balancer in accordance with one embodiment of the present invention.

### DETAILED DESCRIPTION

One embodiment of the present invention is a system that adds a specific server identifier to the URL of a website. A load balancer directs all subsequent requests from a user to the identified server received with the URL.

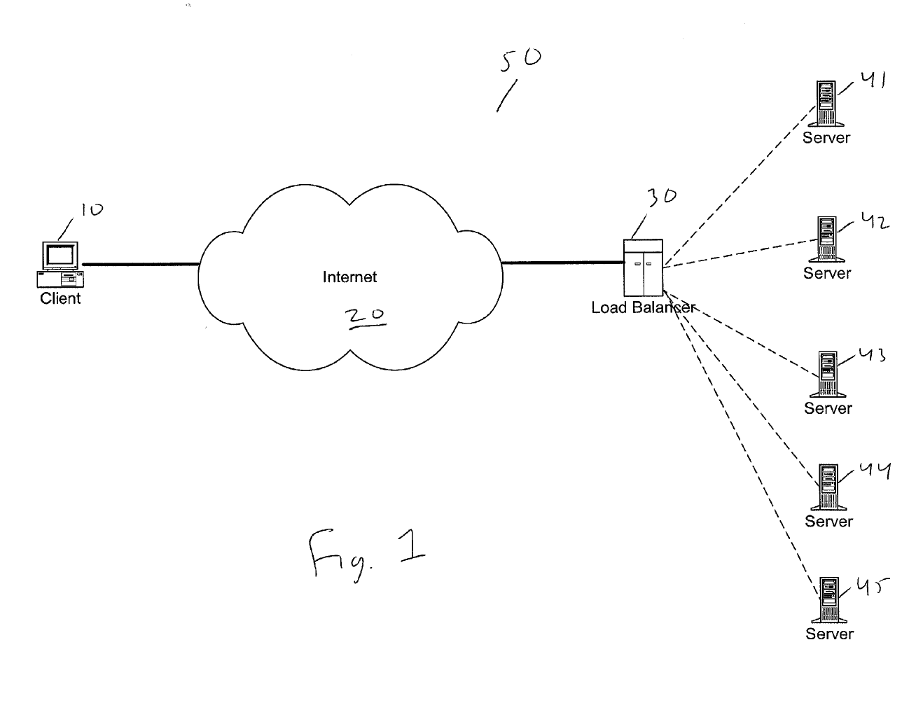

FIG. 1 is a block diagram of a system 50 in accordance with one embodiment of the present invention. System 50 includes the Internet 20 and a client computer 10 that is used to access Internet 20. Client computer 10 can be any known personal computer or other device that includes a web browser. The web browser can be the Internet Explorer from Microsoft Corp., or any other type of browser. Client computer 10 accesses Internet 20 through known methods such as through an Internet service provider (not shown).

System 50 further includes a load balancer 30 coupled to servers 41-45. Servers 41-45 form a group of servers that provide the same or similar content to a user and can each respond to the same URL request from a client. Load balancer 30 can be any known load balancer that is modified to implement the present invention. In one embodiment, load balancer 30 is the NetStructure 7180 e-commerce Director from Intel Corp. that has been modified to perform the steps described below. Load balancer 30 includes a processor and a memory or other type of computer readable medium.

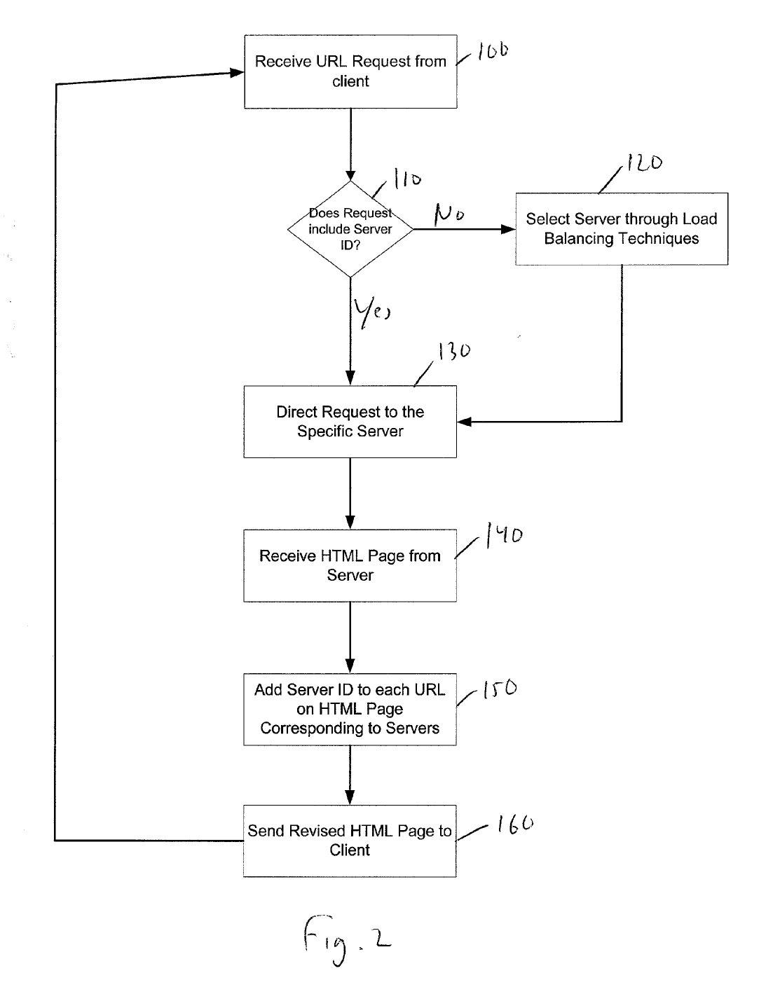

FIG. 2 is a flow diagram of the steps performed by load balancer 30 in accordance with one embodiment of the present invention. In one embodiment, the steps are implemented by software stored in memory and executed by the processor of load balancer 30. In other embodiments, the steps can be performed by hardware, or any combination of hardware and software. The functionality of the steps can also be performed by a device that is separate from, but in communication with, load balancer 30.

At step 100, load balancer 30 receives a URL request from client computer 10. The URL request is directed to a web site that is concurrently located on each of servers 41-45.

At step 110, load balancer 30 determines if the URL request includes the identity of one of servers 41-45 (the “server ID”). If the URL request does not include a server ID, then at step 120 load balancer 30 forwards the URL request to one of servers 41-45 based on known load balancing algorithms or techniques. Load balancing algorithms typically distribute URL requests or queries equitably among servers 41-45 in order to amortize load and improve availability by avoiding downed servers.

If the URL request includes a server ID at step 110, at step 130 load balancer 30 sends the query directly to the server among servers 41-45 that is identified by the server ID.

At step 140, in response to the query received at either step 120 or step 130, the server that received the query returns an HyperText Markup Language (“HTML”) page to load balancer 30 in a known manner. The HTML page would typically include additional URLs that can be selected by a user for further queries among servers 41-45. One example of one of the URLs included on the HTML page is www.xxx.com, which refers to an HTML page that is also located on servers 41-45.

At step 150, load balancer 30 adds a server ID to each of the URLs included in the received HTML page that correspond to an HTML page or query located on servers 41-45. The server ID corresponds to the particular server of servers 41-45 that sent the HTML page to load balancer 30. Using the above example, and assuming that the HTML page was received from server 43, the URL would be changed to www.xxx.com?Sticky=server43, where “sever43” is the server ID for server 43.

Finally, at step 160 the revised HTML page is sent to client computer 10. Subsequent URL requests from client computer 10 at step 100 will now include a server ID.

As described, the present invention sends all requests from client computer 10 to the same server once a connection to that server has been set up. The connection is maintained even if the connection is broken by client computer 10 or the server during a session. Therefore, for example, if during a session a user is placing items in a shopping cart, the current status of the shopping cart will be maintained throughout the session.

The present invention provides an advantage over cookies and URL munging because it is not dependent on the user accepting cookies and unlike URL munging, no costly modifications need be made to the individual web servers. Instead, all modifications are made to the load-balancing device.

Several embodiments of the present invention are specifically illustrated and/or described herein. However, it will be appreciated that modifications and variations of the present invention are covered by the above teachings and within the purview of the appended claims without departing from the spirit and intended scope of the invention.

For example, although the embodiment described involves the Internet and URLs, any communication network can be used and any type of query can be used with the load balancer of the present invention.

1-21. (canceled)

22. A method of accessing data from a plurality of servers comprising:
receiving a request for the data from a client computer;
sending the request to a first server of the plurality of servers, the first server being selected from among the plurality of servers based on server load;
receiving the data from the first server; and
adding an identity of the first server corresponding to a Uniform Resource Locator (URL) associated with the data and forwarding the data to the client computer.

23. A machine-readable medium having stored thereon data representing instructions which, when executed by a machine, cause the machine to perform operations, comprising:
receiving a request for the data from a client computer;
sending the request to a first server of the plurality of servers, the first server being selected from among the plurality of servers based on server load;
receiving the data from the first server; and
adding an identity of the first server corresponding to a Uniform Resource Locator (URL) associated with the data and forwarding the data to the client computer.
